(19) United States
(12) Patent Application Publication
(10) Pub. No.: US 2026/0277155 A1
(43) Pub. Date: Sep. 17, 2026

(54) IMAGE FORMING APPARATUS

(71) Applicant: Akimitsu Obana, Kanagawa (JP)

(72) Inventor: Akimitsu Obana, Kanagawa (JP)

(73) Assignee: ETRIA Co., Ltd., Kanagawa (JP)

(21) Appl. No.: 19/560,305

(22) Filed: Mar. 9, 2026

(30) Foreign Application Priority Data
Mar. 17, 2025 (JP) 2025-041998

(51) Int. Cl. G03G 21/20; G03G 15/20

(52) U.S. Cl. CPC G03G 21/206; G03G 15/2017; G03G 15/2064; G03G 2221/1645

(57) ABSTRACT

An image forming apparatus includes: an apparatus body; an image former detachably attachable to the apparatus body in an attachment direction, the image former to form a toner image on a sheet; and a fixing unit to fix the toner image on the sheet, the fixing unit including: an inlet opening through which the sheet enters into the fixing unit; and a shield to: shield the inlet opening at a shield position when the image former is detached from the apparatus body; or open the inlet opening at an open position when the image former is attached to the apparatus body, wherein the shield, at the open position, forms an air channel between the fixing unit and the image former in the attachment direction to flow air through the air channel.

### CROSS-REFERENCE TO RELATED APPLICATIONS

This patent application is based on and claims priority pursuant to 35 U.S.C. § 119(a) to Japanese Patent Application No. 2025-041998, filed on Mar. 17, 2025, in the Japan Patent Office, the entire disclosure of which is hereby incorporated by reference herein.

### BACKGROUND

### Technical Field

Exemplary aspects of the present disclosure relate to an image forming apparatus.

### Related Art

An image forming apparatus includes an image former that is detachable from an apparatus body and forms a toner image on a sheet, and a fixing unit that fixes the toner image formed on the sheet. The fixing unit includes a shield that shields an inlet opening through which the sheet enters the inside of the fixing unit when the image former is detached from the apparatus body, and opens the inlet opening when the image former is attached to the apparatus body.

### SUMMARY

The present disclosure disclosed herein provides an image forming apparatus includes: an apparatus body; an image former detachably attachable to the apparatus body in an attachment direction, the image former to form a toner image on a sheet; and a fixing unit to fix the toner image on the sheet, the fixing unit including: an inlet opening through which the sheet enters into the fixing unit; and a shield to: shield the inlet opening at a shield position when the image former is detached from the apparatus body; or open the inlet opening at an open position when the image former is attached to the apparatus body, wherein the shield, at the open position, forms an air channel between the fixing unit and the image former in the attachment direction to flow air through the air channel.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A and 1B are schematic perspective views each illustrating a monochrome laser printer as an image forming apparatus;

FIG. 2 is a schematic sectional view illustrating a basic configuration of the monochrome laser printer;

FIG. 3 is a diagram illustrating a characteristic of the printer;

FIG. 4 is a diagram illustrating an internal portion of the printer when an image former is detached from an apparatus body;

FIG. 5 is an enlarged view illustrating the vicinity of a fixing unit;

FIG. 6 is a diagram illustrating a first modification; and

FIGS. 7A and 7B are diagrams each illustrating a second modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, the present embodiment is described with reference to the drawings. In each of the drawings, elements such as members and components having the same function or shape are given the same reference numerals as long as the same function or shape can be determined, and redundant descriptions thereof are omitted.

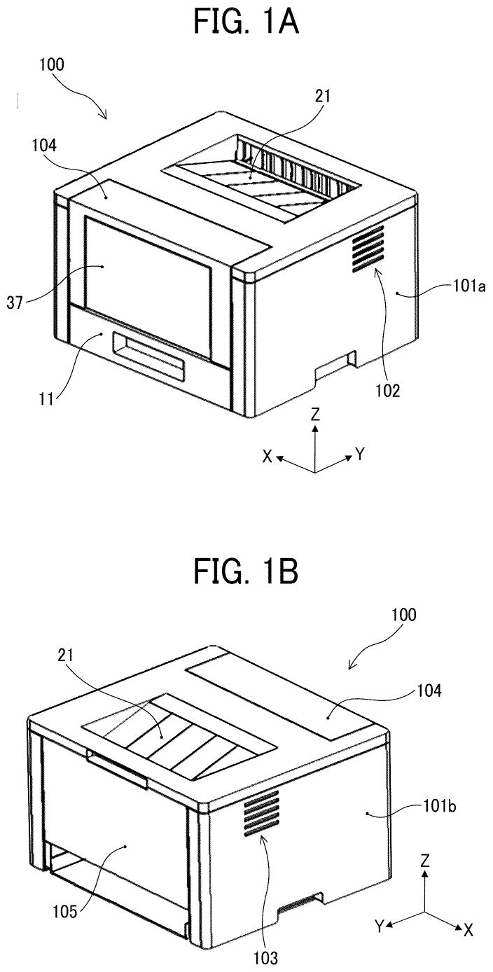

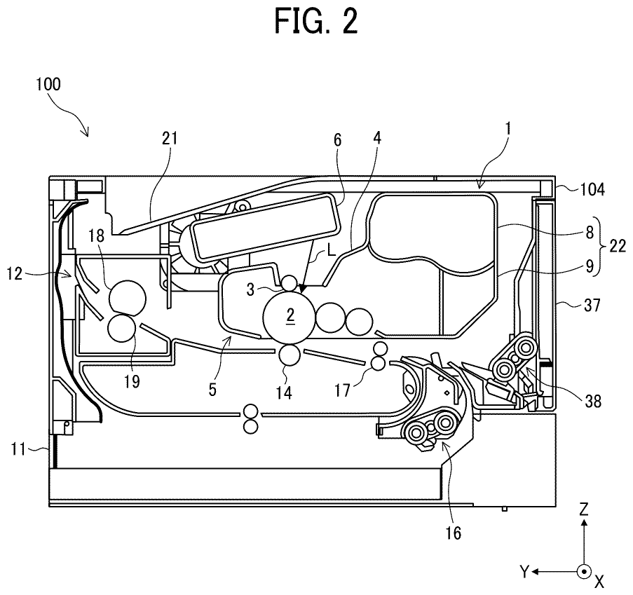

FIG. 1A and1B are schematic perspective views each illustrating a monochrome laser printer (also simply referred to as a printer) 100 as an image forming apparatus, and FIG. 2 is a schematic sectional view illustrating a basic configuration of the monochrome laser printer 100. FIG. 1A is a perspective view of the monochrome laser printer 100 as seen from the front side, whereas FIG. 1B is a perspective view of the monochrome laser printer 100 as seen from the rear side. In each of FIGS. 1A and 1B, a Z direction represents a vertical direction, a Y direction represents a front-rear direction of the apparatus, and an X direction represents a horizontal direction of the apparatus.

In the following description, the term “image forming apparatus” represents an apparatus that forms an image by causing toner or ink as developer to adhere to a sheet as a recording medium on which the image is to be recorded. The term “image forming” represents not only a case where a meaningful image such as text and graphics is provided on a medium, but also a case where a meaningless image such as patterns is provided on a medium. The term “sheet” includes not only paper (a sheet), but also cloth and an overhead projector (OHP) sheet, and represents a medium or a document to which developer can adhere. Moreover, the term “sheet” includes thick paper, a post card, an envelope, thin paper, coated paper (e.g., art paper), and tracing paper in addition to plain paper. In the following embodiment, toner is described as “developer”, and a sheet is described as “paper”. Dimensions, materials, shape, and relative arrangement of each component described in the embodiment are merely examples, and are not intended to limit the scope of the present disclosure unless otherwise specified.

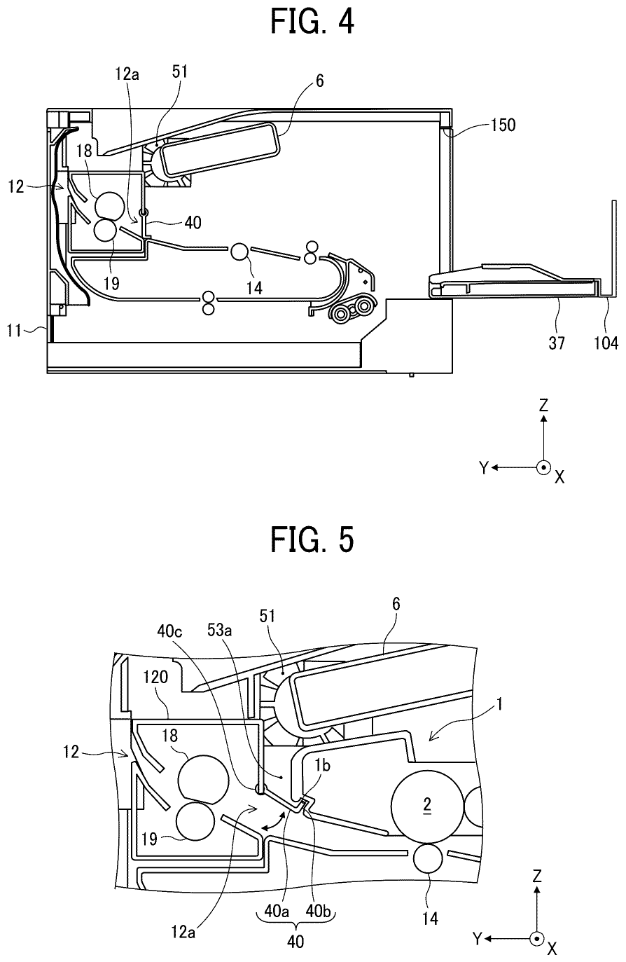

As illustrated in FIG. 1A, on the front side of the monochrome laser printer 100, a front cover 104 is rotatably arranged with respect to a printer body (also referred to as an apparatus body). When the front cover 104 is opened, a front opening 150 (see FIG. 4) for attachment and detachment of an image former 1 (see FIG. 2) is opened. A manual tray 37 is rotatably attached to the front cover 104.

As illustrated in FIG. 1B, on the rear side of the printer 100, a rear cover 105 is rotatably arranged with respect to the printer body. When the rear cover 105 is opened, a post-fixing conveyance path from a fixing unit 12 (see FIG. 2) to an ejection tray 21 is exposed so that a sheet jammed in the post-fixing conveyance path can be removed. In addition, vent holes 102 and 103 are respectively arranged on a right surface 101a and a left surface 101b of the monochrome laser printer 100. Thus, air intake and air exhaust are performed between the inside and the outside of the printer 100 via the vent holes 102 and 103.

Next, main portions of the printer 100 are described with reference to FIG. 2. The printer 100 includes the image former 1 in an image forming area. The image former 1 forms an image using black developer. The image former 1 includes a photoconductor 2 (a photoconductor drum) as an image bearer that bears an image on a surface thereof, and a charging device 3 as a charging unit that charges a surface of the photoconductor 2. The image former 1 also includes a developing device 4 as a developing unit that renders a latent image on the photoconductor 2 visible, a drum cleaning device 5 as a cleaning unit that cleans the surface of the photoconductor 2, and a charge removal device that removes electric charge from the surface of the photoconductor 2.

Moreover, the image former 1 includes a toner cartridge 22 as a developer container. The toner cartridge 22 is detachably disposed to the image former 1. The toner cartridge 22 includes a developer bottle 8 in which toner as developer to be supplied to the developing device 4 is stored. Moreover, the toner cartridge 22 integrally includes a developer collection unit 9 that collects a toner (a waste toner) removed by the drum cleaning device 5.

The image former 1 is detachable from the printer body which is the apparatus body, and consumable parts can be replaced. In FIG. 2, a laser scan unit (LSU) 6 that irradiates a surface of the photoconductor 2 with light L is disposed on the upper left side of the image former 1. The LSU 6 emits the light L to the surface of the photoconductor 2 based on image data. Moreover, a transfer roller 14 as a transfer unit that transfers an image on the photoconductor 2 to a sheet is disposed in a position facing the photoconductor 2. The transfer roller 14 is disposed in a position in which the transfer roller 14 can contact the photoconductor 2, and a transfer nip is formed in a contact area between the transfer roller 14 and the photoconductor 2.

In a lower portion of the printer body, a feed unit 16 as a feeding unit that feeds a sheet stacked on a sheet feeding tray 11 is disposed. In a side surface portion of the apparatus body, the manual tray 37 is disposed, and a manual feed unit 38 as a feeding unit that feeds a sheet stacked on the manual tray 37 is disposed. Moreover, a timing roller pair 17 is disposed on a downstream side of the manual feed unit 38 in a sheet conveyance direction and an upstream side of the transfer nip. The timing roller pair 17 temporarily stops a sheet, and then conveys the sheet at a predetermined time.

In addition, the fixing unit 12 for fixing the image transferred to the sheet is disposed on a downstream side of the transfer nip in the sheet conveyance direction. The fixing unit 12 includes a fixing roller 18 and a pressure roller 19. The fixing roller 18 includes a heat source such as a halogen lamp, and the pressure roller 19 rotates while contacting the fixing roller 18 with a predetermined pressure.

Next, a basic operation of the printer 100 is described. When a sheet is fed from the sheet feeding tray 11, the feed unit 16 separates a top sheet from the sheets stacked on the sheet feeding tray 11 and feeds the separated sheet to a sheet conveyance path. When a sheet is fed from the manual tray 37, the manual feed unit 38 separates a top sheet from the sheets stacked on the manual tray 37 and feeds the separated sheet to the sheet conveyance path. When a leading end of the sheet reaches the nip portion of the timing roller pair 17, the sheet is timed (synchronized) with a toner image formed on the photoconductor 2, and waits in a state in which the sheet is slackened so that skew of the leading end of the sheet is corrected.

In the image former 1, a toner image is formed on a surface of the photoconductor 2 as follows. The charging device 3 uniformly charges a surface of the photoconductor 2 to a high potential, and the LSU 6 irradiates the surface of the photoconductor 2 with the light L based on image information from a device such as a reading device and a computer. Accordingly, a potential of the area irradiated with the light L is reduced, so that an electrostatic latent image is formed on the surface of the photoconductor 2. The developing device 4 supplies toner to the electrostatic latent image, and a toner image (a developer image) is formed (developed) on the surface of the photoconductor 2.

When the toner image is formed on the photoconductor 2, the timing roller pair 17 starts running, and the sheet is conveyed to a transfer nip in time (synchronization) with the toner image on the photoconductor 2. Then, the transfer roller 14 transfers the toner image on the photoconductor 2 to the conveyed sheet. The drum cleaning device 5 removes residual toner not transferred to the sheet and remaining on the photoconductor 2. Subsequently, the electric charge on the surface of the photoconductor 2 is removed by the electric removal device.

The sheet to which the toner image has been transferred is conveyed to the fixing unit 12 via a post-transfer conveyance path. The sheet conveyed to the fixing unit 12 is nipped by the fixing roller 18 and the pressure roller 19, and an unfixed toner image is fixed on the sheet with heat and pressure. The sheet with the fixed toner image is conveyed from the fixing unit 12 to a post-fixing conveyance path, and then is ejected to the ejection tray 21.

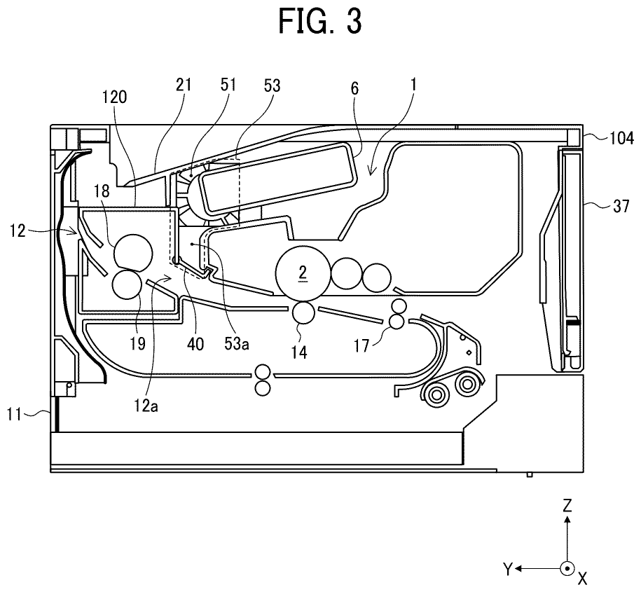

FIG. 3 is a diagram illustrating a characteristic of the printer 100. As illustrated in FIG. 3, the fixing unit 12 includes a shield 40 as a shield that shields an inlet opening 12a through which a sheet enters the fixing unit 12. The shield 40 is rotatably attached to a case 120 of the fixing unit 12. As illustrated in FIG. 3, when the image former 1 is attached to the apparatus body, the shield 40 is positioned in an open position to open the inlet opening 12a.

The shield 40 is rotated clockwise from the open position illustrated in FIG. 3 to a shielding position illustrated in FIG. 4 in response to opening of the front cover 104 or detachment of the image former 1 from the printer body. The shield 40 is positioned in the open position to open the inlet opening 12a, whereas the shield 40 is positioned in the shielding position to shield the inlet opening 12a. A mechanism for rotating the shield 40 in response to opening and closing of the front cover 104, or a mechanism for rotating the shield 40 in response to attachment and detachment of the image former 1 can be a known method.

For example, the mechanism for rotating the shield 40 in response to attachment and detachment of the image former 1 employes an urging member such as a torsion spring. The urging member urges the shield 40 such that the shield 40 is positioned in the shielding position illustrated in FIG. 4. Also, a receiving portion is arranged in one end of a pivot shaft that rotates with the shield 40, and a pressing portion is arranged in the image former 1. The pressing portion presses the receiving portion in an attachment direction (+Y direction) of the image former 1 at the time of attachment of the image former 1. When the image former 1 is attached to the printer body, the pressing portion arranged in the image former 1 contacts the receiving portion and presses the receiving portion in the +Y direction. Then, the receiving portion moves toward the +Y direction, so that the pivot shaft rotates counterclockwise in FIG. 4. Accordingly, against an urging force of the urging member, the shield 40 is rotated counterclockwise in FIG. 4 with the pivot shaft. This enables the shield 40 to be moved from the shielding position illustrated in FIG. 4 to the open position illustrated in FIG. 3. When the image former 1 is detached from the printer body, the pressure against the receiving portion by the pressing portion of the image former 1 is released. Thus, the shield 40 is rotated clockwise in FIG. 3 by the urging force of the urging member, and is moved from the open position to the shielding position.

An example of the mechanism for rotating the shield 40 in response to opening and closing of the front cover 104 includes a configuration as follows. When the front cover 104 and the shield 40 are connected by wire and the front cover 104 is closed, the wire pulls the shield 40 to cause the shield 40 to be positioned in the open position illustrated in FIG. 3. When the front cover 104 is opened, the wire is slackened, and the shield 40 is rotated clockwise in FIG. 3 by an urging force of the urging member and is moved to the shielding position.

As illustrated in FIG. 4, when the image former 1 is detached from the printer body, the inlet opening 12a is shielded by the shield 40. Accordingly, when the front opening 150 is exposed by the opening of the front cover 104, and a user puts one's hand into the printer body from the opened front opening 150 of the printer body, the hand can be prevented from contacting a high-temperature portion including the fixing roller 18 inside the fixing unit 12. In addition, a phenomenon such as discharge can be prevented from occurring between an electrical component such as a halogen heater inside the fixing unit 12 and a finger of the user.

When the image former 1 is attached to the printer body, the shield 40 is positioned in the open position as illustrated in FIG. 3, and the inlet opening 12a is opened. Such opening of the inlet opening 12a enables the sheet with the transferred toner image to enter the inside of the fixing unit 12.

At the time of image forming operation, the air between the fixing unit 12 and the image former 1 may be heated by heat generated by the fixing unit 12, and such heated air may heat the image former 1. Consequently, temperature of the image former 1 may rise. Moreover, when the air near the fixing unit 12 is heated by the heat of the fixing unit 12, the heated air may move up. Consequently, the LSU 6 may be heated, and temperature of the LSU 6 may rise.

In the present embodiment, as illustrated in FIGS. 3 and 4, an intake fan 51 as an airflow generator is disposed on one end of the printer body (the right end of the printer) in a horizontal direction (an X direction) that is a longitudinal direction of the fixing unit 12, and an exhaust fan is disposed on the other end (the left end of the printer). The intake fan 51 is disposed opposite the vent hole 102 arranged on the right surface 101a of the printer 100. The exhaust fan is disposed opposite the vent hole 103 arranged on the left surface 101b of the printer 100. Depending on a linear velocity (a sheet conveyance speed) or a set temperature of the fixing unit 12 (ability for increasing a temperature inside the image forming apparatus), either the intake fan 51 or the exhaust fan may be disposed, or a combination of the intake fan 51 and the exhaust fan may be changed as appropriate.

The intake fan 51 and the exhaust fan are driven when the image former 1 is attached to the apparatus body and the shield 40 is positioned in the open position. The driving of the intake fan 51 and the exhaust fan generates airflow that causes the outside air introduced into the apparatus to flow in the X direction in a dotted line area 53 in FIG. 3.

As illustrated in FIG. 3, the LSU 6 has a fixing unit side that is arranged opposite the intake fan 51. Accordingly, the outside air introduced into the printer 100 via the vent hole 102 by the intake fan 51 hits the fixing unit side of the LSU 6, so that the LSU 6 is cooled by the air. Moreover, the introduced outside air flows in the horizontal direction (the X direction) of the apparatus along a periphery of the fixing unit side of the LSU 6, so that the fixing unit side is cooled by the air. Then, the air which has removed the heat from the LSU 6, or the heat which is from the fixing unit and has moved up to the LSU 6 is exhausted to the outside of the apparatus by the exhaust fan.

Moreover, a part of the outside air introduced by the intake fan 51 flows to an air channel 53a between the image former 1 and the fixing unit 12. Then, the air flows inside the air channel 53a in a left direction (X direction) of the apparatus, and is exhausted to the outside of the apparatus by the exhaust fan. Accordingly, a temperature rise between the fixing unit 12 and the image former 1 is reduced, and a temperature rise of the image former 1 due to the heat of the fixing unit 12 is reduced. In addition, the fixing unit side of the image former 1 is cooled by the airflow flowing in the X direction inside the air channel 53a and the airflow flowing between the LSU 6 and the image former 1 in a longitudinal direction of the fixing unit 12 (i.e., a horizontal direction of the apparatus, the X direction). Thus, a temperature rise of the image former 1 due to heat generated in the image former 1 can be reduced.

As illustrated in FIG. 3, the shield 40 is positioned in the open position, so that the air introduced from the intake fan 51 is guided in the X direction by the shield 40, and the air channel 53a through which the air flows in the X direction is formed between the fixing unit 12 and the image former 1. Thus, a duct for causing the air introduced from the intake fan 51 to flow in the X direction between the image former 1 and the fixing unit 12 can be eliminated. Accordingly, a space for the duct does not need to be arranged between the image former 1 and the fixing unit 12, and the apparatus can be made compact. In addition, the number of components can be reduced, and the cost of the apparatus can be reduced.

The shield 40 is cooled by the air flowing through the air channel 53a, and a temperature rise of the shield 40 is reduced. This can reduce the thermal sensation of a user when the user contacts the shield 40 when the image former 1 is detached.

Japanese Patent No. 4759161 discloses a fixing shutter that opens and closes an inlet opening of a fixing unit. The fixing unit includes multiple holes through which air passes. When the fixing shutter is positioned in an open position, an airflow passing through the holes of the fixing shutter and flowing upward between the fixing unit and an image former is generated.

However, since the fixing shutter in Japanese Patent No. 4759161 includes the multiple holes, the fixing shutter does not shield the inlet opening. The term “shield” represents concealment by blocking and covering. The fixing shutter including the multiple holes in Japanese Patent No. 4759161 does not block or cover the inside of the fixing unit or does not serve as a shield since the inside of the fixing unit is seen from the holes. In such a configuration in which the fixing shutter includes holes and the inlet opening is not shielded, discharge may occur between an electrical component such as a halogen heater inside the fixing unit and a user hand that is put into a printer body from a front opening of the printer body. Such discharge occurs via the hole of the fixing shutter. Consequently, the fixing shutter needs to be spaced a certain distance apart from the electrical component inside the fixing unit to prevent discharge from occurring between the user hand and the electric component inside the fixing unit via the hole, and such arrangement causes an increase in size of the fixing unit.

In the present embodiment, on the other hand, the inlet opening 12a is shielded by the shield 40. Thus, even if a spatial distance between the shield 40 and an electrical component inside the fixing unit 12 is short, discharge does not occur between the electrical component inside the fixing unit 12 and a user hand that is input into the printer body from the front opening 150 of the printer body. Therefore, an increase in the size of the fixing unit can be reduced in comparison with the case disclosed in Japanese Patent No. 4759161.

FIG. 5 is an enlarged view illustrating the vicinity of the fixing unit 12. The shield 40 includes a plane portion 40a and a projection portion 40b. The plane portion 40a shields the inlet opening 12a, and the projection portion 40b as an engagement portion projects toward the image former 1 (an upstream side in a sheet conveyance direction) from a leading end of the plane portion 40a (an end portion on the side opposite a rotation fulcrum 40c of the shield 40).

As illustrated in FIG. 5, when the shield 40 is positioned in the open position, the projection portion 40b is engaged with a groove 1b arranged on an outer side face of a case of the image former 1. Accordingly, the air flowing through the air channel 53a in the X direction cannot be leaked from a clearance between the image former 1 and the shield 40. Thus, a decrease in a flow rate of the air inside the air channel 53a can be prevented, a decrease in heat exhaust efficiency of the fixing unit 12 can be prevented, and a temperature rise between the image former 1 and the fixing unit 12 can be appropriately reduced. Therefore, a temperature rise of the image former 1 due to the heat of the fixing unit 12 can be appropriately reduced. Moreover, the leakage of the air between the image former 1 and the shield 40 can be reduced without an additional component, and an increase in the cost of the apparatus can be reduced.

Next, modifications are described.

### First Modification

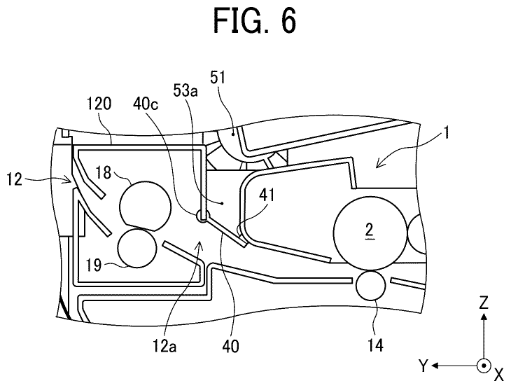

FIG. 6 is a diagram illustrating a first modification. In the first modification as illustrated in FIG. 6, an elastic member 41 is disposed on a leading end of a plate-shape shield 40 at a side opposite an image former 1 (on an end portion of the shield 40 at a side opposite a rotation fulcrum 40c). As illustrated in FIG. 6, when the shield 40 is positioned in an open position, the elastic member 41 is elastically deformed by contacting a case of the image former 1 and thus closely contacts the case of the image former 1. Accordingly, a clearance between the image former 1 and the shield 40 can be eliminated. Hence, the air flowing inside an air channel 53a in an X direction is prevented from leaking from the clearance between the image former 1 and the shield 40. Thus, a flow rate of the air inside the air channel 53a can be appropriately controlled, and a decrease in heat exhaust efficiency of the heat of a fixing unit 12 can be controlled. As a result, and a temperature rise between the image former 1 and the fixing unit 12 can be appropriately reduced. The elastic member 41 can be made of a material such as sponge and rubber, but the material for the elastic member 41 is not limited thereto as long as the elastic member 41 can follow a surface of the case by elastic deformation when the elastic member 41 contacts the case of the image former 1.

### Secon Modification

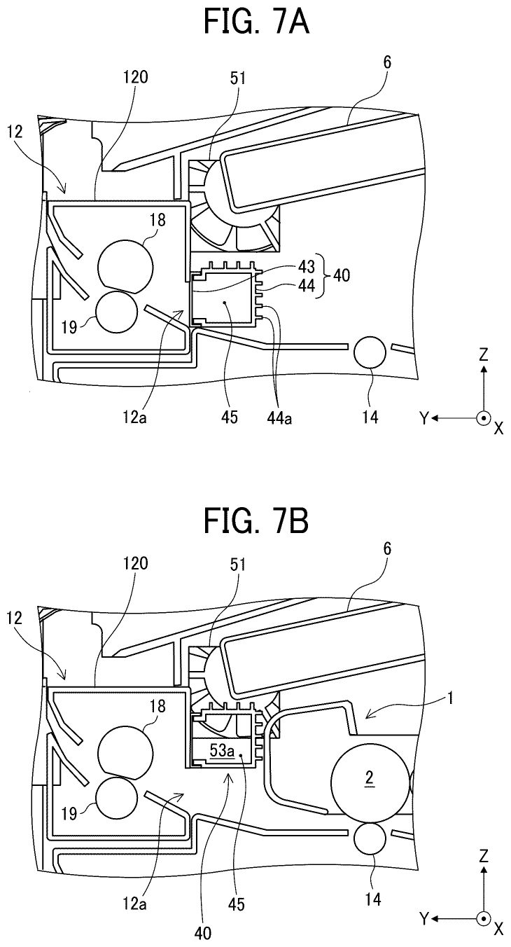

FIGS. 7A and 7B are diagrams each illustrating a second modification. As illustrated in FIGS. 7A and 7B, a shield 40 includes a first member 43 made of metal and a second member 44 made of resin. The shield 40 has a duct 45 that forms an air channel 53a through which air flows in an X direction between a fixing unit 12 and an image former 1.

The first member 43 made of metal has a plate shape. The second member 44 made of resin includes an opposite wall and a pair of horizontal walls. The opposite wall is disposed opposite the first member 43 with a predetermined distance apart from an image former side, and the pair of horizontal walls extends from an upper end and a lower end of the opposite wall in a front-rear diction (a Y direction) of a printer, that is, in a sheet conveyance direction toward a fixing unit 12. The horizontal wall portions have respective leading ends that are connected to an upper end and a lower end of the plate-shaped first member 43, and thus the duct 45 having shape of a square tube is formed. The shield 40 is disposed to a case 120 of the fixing unit 12 so as to be slidable in a vertical direction (a Z direction).

In the second modification, the first member 43 on the fixing unit side is formed of metal, so that thermal deformation by heat of the fixing unit 12 can be reduced, and a failure in slide movement of the shield 40 between a shielding position illustrated in FIG. 7A and an open position illustrated in FIG. 7B can be prevented.

Since the first member 43 is made of metal and has high thermal conductively, the temperature of the first member 43 rises more easily. Consequently, when the image former 1 is detached and an inlet opening 12a is shielded by the shield 40, the heat inside the fixing unit 12 may cause the first member 43 to reach a high temperature.

In the second modification, however, the first member 43 is covered with the second member 44. Accordingly, when the image former 1 is detached, a finger of a user can be prevented from contacting the first member 43. There is a danger that the finger of the user may contact the second member 44. However, since the second member 44 is made of a low-thermal-conductivity resin material, heat transfer from the first member 43 is reduced, and the second member 44 is maintained at a low temperature. Thus, even when the image former 1 is detached and the user contacts the shield 40 in the shielding position by putting one's hand into a printer body from a front opening 150 used for attachment and detachment of the image former 1, and the user does not feel the heat from the fixing unit 12.

In the second modification, moreover, multiple ribs 44a are arranged on an outer circumferential surface of the second member 44. Such arrangement of the multiple ribs 44a on the outer circumferential of the second member 44 can reduce an area in which a finger of the user contacts the shield 40, and thus can further reduce the thermal sensation of the user when the user contacts the shield 40.

As illustrated in FIG. 7B, when the image former 1 is attached and the shield 40 is positioned in an open position, the duct 45 of the shield 40 is positioned between the fixing unit 12 and the image former 1. Moreover, one portion of an opening of the duct 45 overlaps one portion of an intake fan 51 and one portion of an exhaust fan as viewed from an X direction. Accordingly, one portion of the airflow generated by the intake fan 51 or the exhaust fan appropriately flows inside the duct 45, so that an airflow by which the air flows in the X direction is generated inside the duct 45. Thus, a temperature rise between the image former 1 and the fixing unit 12 is reduced, so that a temperature rise of the image former 1 due to the heat of the fixing unit 12 can be reduced.

In the second modification, an air channel through which air flows in the X direction is formed between the image former 1 and the fixing unit 12 by the shield 40. Accordingly, the number of components can be smaller and the cost of the apparatus can be lower than those of a case in which a duct is disposed separately from the shield 40.

Moreover, in the second modification, a duct may be disposed separately from the shield 40. In such a case, the duct needs to be shortened in a Y direction by a thickness of the shield 40 such that the shield 40 can slide upward to be positioned in an open position. Accordingly, the arrangement of the duct 45 in the shield 40 can provide a larger cross-sectional area of a duct channel than that of a case in which a duct is disposed separately from a shield, thereby increasing a flow rate of the air flowing inside the duct 45. Thus, a decrease in heat exhaust efficiency can be prevented, and a temperature rise between the image former 1 and the fixing unit 12 can be appropriately reduced.

Moreover, in the second modification, since the air channel 53a through which the air flows in the X direction between the fixing unit 12 and the image former 1 is enclosed by walls on all sides, the air can flow from one end to the other end in the X direction without leaking partway. Accordingly, a flow rate of the air channel 53a is not decreased, and the heat of the fixing unit 12 can be efficiently exhausted to the outside of the apparatus. Thus, a temperature rise between the image former 1 and the fixing unit 12 can be appropriately reduced, and a temperature rise of the image former 1 can be appropriately reduced.

An image forming apparatus includes: an apparatus body; an image former detachably attachable to the apparatus body in an attachment direction, the image former to form a toner image on a sheet; and a fixing unit to fix the toner image on the sheet, the fixing unit including: an inlet opening through which the sheet enters into the fixing unit; and a shield to: shield the inlet opening at a shield position when the image former is detached from the apparatus body; or open the inlet opening at an open position when the image former is attached to the apparatus body, wherein the shield, at the open position, forms an air channel between the fixing unit and the image former in the attachment direction to flow air through the air channel.

The image forming apparatus further includes: an airflow generator to generate an airflow flowing through the air channel from one end to another end of the fixing unit in a longitudinal direction of the fixing unit, orthogonal to the attachment direction, and the airflow generator is disposed at one end of the apparatus body in the longitudinal direction. The airflow generator generates the airflow when the shield is at the open position.

The image former has a groove on an outer side face of the image former, the shield includes: a plane portion to shield the inlet opening; and an engagement portion projecting from the plane portion, and the engagement portion is engaged with the groove on the image former when the shield is at the open position. The shield includes an elastic member in contact with the image former when the shield is at the open position. The shield includes a duct forming the air channel.

The shield includes multiple members forming a duct. The multiple members of the shield include: a first member made of metal; and a second member made of resin, the second member facing the first member and forming a part of the duct with the first member, and the multiple members are movable between the open position and the shield position. The second member has multiple projections on an outer circumferential surface of the second member.

According to the present embodiment, the apparatus can be made compact, and the cost of the apparatus can be reduced.

The present embodiment has been described above with reference to specific embodiment but is not limited thereto. Various modifications and enhancements are possible without departing from scope of the disclosure.

The above description is merely one example. The present disclosure can provide the effects described below.

### Aspect 1

An image forming apparatus includes an image former 1 that is detachable from an apparatus body and forms a toner image on a sheet such as paper, and a fixing unit 12 that fixes the toner image formed on the sheet. The fixing unit 12 includes a shield as a shield 40 that shields an inlet opening 12a through which the sheet enters an inside of the fixing unit 12 when the image former 1 is detached from the apparatus body, and opens the inlet opening 12a when the image former 1 is attached to the apparatus body. The shield forms an air channel 53a through which air flows between the fixing unit 12 and the image former 1 when the shield is positioned in an open position to open the inlet opening 12a. Since the air channel through which the air flows is formed between the fixing unit 12 and the image former 1 by the shield, arrangement of a duct can be eliminated. Thus, a duct space is not necessary between the fixing unit 12 and the image former 1, and an increase in size of the apparatus can be reduced. In addition, the number of components can be smaller and the cost of the apparatus can be lower than those of a case in which a duct is arranged.

### Aspect 2

In the aspect 1, the air channel 53a causes air to flow from one end toward the other end of the fixing unit 12 in a longitudinal direction (X direction), and includes an airflow generator (an intake fan 51 or an exhaust fan). The airflow generator is disposed in at least one of one end and the other end of the apparatus body in the longitudinal direction. The airflow generator generates an airflow in the air channel 53a. Accordingly, an airflow by which the air flows one end to the other end in the longitudinal direction (X direction) can be generated in the air channel 53a, and a region between the fixing unit 12 and the image former 1 can be appropriately cooled.

### Aspect 3

In the aspect 2, when the shield such as the shield 40 is positioned in the open position, the airflow generator (the intake fan 51 or the exhaust fan) generates an airflow. Accordingly, an airflow can be generated in the air channel 53a between the 12 and the image former 1 when the fixing unit 12 is driven. The airflow of the air channel 53a enables heat heading for the image former 1 when the fixing unit 12 is driven to flow to the other end side in the longitudinal direction, and a temperature rise of the image former 1 can be reduced.

### Aspect 4

In any of the aspects 1 through 3, the shield such as the shield 40 includes a plane portion 40a that shields the inlet opening 12a and an engagement portion as a projection portion 40b projecting from the plane portion 40a. The engagement portion is engaged with a groove 1b arranged in the image former 1 when the shield is positioned in the open position. Accordingly, as described with reference to FIG. 5, the air in the air channel 53a can be prevented from leaking from a clearance between the image former 1 and the shield such as the shield 40. Thus, a decrease in a flow rate of the air flowing to the air channel 53a can be reduced, and a decrease in a heat exhaust efficiency of the heat between the fixing unit 12 and the image former 1 can be reduced. As a result, a temperature rise between the fixing unit 12 and the image former 1 can be appropriately reduced, and a temperature rise of the image former 1 due to the heat of the fixing unit 12 can be appropriately reduced.

### Aspect 5

In any of the aspects 1 through 3, the shield such as the shield 40 includes an elastic member 41 that contacts the image former 1 when the shield is positioned in the open position. Accordingly, as described in the first modification, the elastic member 41 is elastically deformed to follow an outer circumferential surface of the image former 1, so that the elastic member 41 can closely contact the image former 1. Accordingly, the air in the air channel can be prevented from leaking from a clearance between the image former 1 and the shield such as the shield 40. Thus, a decrease in a flow rate of the air flowing to the air channel 53a can be appropriately reduced, and a decrease in a heat exhaust efficiency of the heat between the fixing unit 12 and the image former 1 can be reduced. As a result, a temperature rise between the fixing unit 12 and the image former 1 can be appropriately reduced, and a temperature rise of the image former 1 due to the heat of the fixing unit 12 can be appropriately reduced.

### Aspect 6

In any of the aspects 1 through 3, the shield such as the shield 40 includes a duct 45 that forms the air channel 53a. Accordingly, as described in the second modification, a duct channel can have a larger cross-sectional area than that of a case in which a duct is disposed separately from the shield 40, thereby increasing a flow rate of the air flowing inside the duct. Thus, a decrease in heat exhaust efficiency can be reduced, and a temperature rise between the image former 1 and the fixing unit 12 can be appropriately reduced.

### Aspect 7

In any of the aspects 1 through 6, the shield such as the shield 40 includes multiple members. As described in the second modification, a member such as a metal member that is not prone to thermal deformation can be used on the side near the fixing unit, and a member having low thermal conductivity can be used in a portion of the shield which may be contacted by a finger of a user when the shield is positioned in a shielding position. Accordingly, not only a failure in slide movement between the shielding position and the open position of the shield can be reduced, but also the thermal sensation of the user can be reduced when a finger of the user contacts the shield when the shield is positioned in the shielding position.

### Aspect 8

In the aspect 7, the shield such as the shield 40 includes a first member 43 made of metal and a second member 44 made of resin. The second member 44 is positioned on the side near the image former 1 relative to the first member 43 and covers the first member 43. As described in the second modification, since the first member 43 is formed of metal, deformation of the first member 43 due to heat of the fixing unit 12 can be reduced, and a failure in slide movement between the shielding position and the open position of the shield can be reduced. The metal-made first member 43 has a side near the image former, and such a side is covered with the second member 44. Thus, when the image former 1 is detached from the apparatus body, and the shield is positioned in the shielding position, the user can be prevented from contacting the second member 44 and the first member 43 with a finger. Since the second member 44 made of resin has lower thermal conductivity than the first member 43 made of metal, a temperature rise of the second member 44 due to heat of the fixing unit can be more reduced than that of the first member 43. Thus, such arrangement can reduce the thermal sensation of the user when the user contacts the shield with a finger.

### Aspect 9

In the aspect 8, the second member 44 has an outer circumferential surface on which multiple projections such as ribs 44a are formed. Accordingly, as described in the second modification, a contact area in which the user contacts the second member 44 with a finger can be reduced, and the thermal sensation of the user can be reduced.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. An image forming apparatus comprising:
an apparatus body;
an image former detachably attachable to the apparatus body in an attachment direction, the image former to form a toner image on a sheet; and
a fixing unit to fix the toner image on the sheet, the fixing unit including:
an inlet opening through which the sheet enters into the fixing unit; and
a shield to:
shield the inlet opening at a shield position when the image former is detached from the apparatus body; or
open the inlet opening at an open position when the image former is attached to the apparatus body,
wherein the shield, at the open position, forms an air channel between the fixing unit and the image former in the attachment direction to flow air through the air channel.

2. The image forming apparatus according to claim 1, further comprising:
an airflow generator to generate an airflow flowing through the air channel from one end to another end of the fixing unit in a longitudinal direction of the fixing unit, orthogonal to the attachment direction, and
the airflow generator is disposed at one end of the apparatus body in the longitudinal direction.

3. The image forming apparatus according to claim 2,
wherein the airflow generator generates the airflow when the shield is at the open position.

4. The image forming apparatus according to claim 1,
wherein the image former has a groove on an outer side face of the image former,
the shield includes:
a plane portion to shield the inlet opening; and
an engagement portion projecting from the plane portion, and
the engagement portion is engaged with the groove on the image former when the shield is at the open position.

5. The image forming apparatus according to claim 1,
wherein the shield includes an elastic member in contact with the image former when the shield is at the open position.

6. The image forming apparatus according to claim 1,
wherein the shield includes a duct forming the air channel.

7. The image forming apparatus according to claim 6,
wherein the shield includes multiple members forming a duct.

8. The image forming apparatus according to claim 7,
wherein the multiple members of the shield include:
a first member made of metal; and
a second member made of resin,
the second member facing the first member and forming a part of the duct with the first member, and
the multiple members are movable between the open position and the shield position.

9. The image forming apparatus according to claim 8,
wherein the second member has multiple projections on an outer circumferential surface of the second member.
